(19) United States
(12) Patent Application Publication
(10) Pub. No.: US 2012/0320182 A1
(43) Pub. Date: Dec. 20, 2012

(54) ELECTRO OPTICAL IMAGE-MAGNIFYING DEVICE

(76) Inventor: RICHARD HUBBARD, Marina, CA (US)

(21) Appl. No.: 13/233,421

(22) Filed: Sep. 15, 2011

Related U.S. Application Data
(60) Provisional application No. 61/498,378, filed on Jun. 17, 2011.

(51) Int. Cl. H04N 7/18

(52) U.S. Cl. 348/79; 348/E07.085

(57) ABSTRACT

An electro optical image-magnifying device uses both a light image and electrons to form and enlarge the image. The device may be attached to a microscope or a telescope and may be placed in such a way that an image plane may fall on a photo cathode in the front of the device. The operator would view the image produced on a display screen, or thru an eyepiece, and would adjust a control power supply to achieve the desired magnification. The device may use both a light image and electrons to form and enlarge an image. The device may convert the light image into an electron wave representation. The electron wave representation may be manipulated electrically or magnetically, expanding its geometry and thus magnifying the image.

### CROSS-REFERENCE TO RELATED APPLICATIONS

This application claims the benefit of priority of U.S. provisional patent application No. 61/498,378, filed Jun. 17, 2011, the contents of which are herein incorporated by reference.

### BACKGROUND OF THE INVENTION

The present invention relates to image magnifying devices and, more particularly, to an electro optical image magnifying device.

Present art uses electro optical components to amplify the optical image's intensity or brightness but do not magnify the image to any great degree.

As can be seen, there is a need for electro optical image devices that may be capable of magnify an optical image.

### SUMMARY OF THE INVENTION

In one aspect of the present invention, an electro optical image-magnifying device comprises a housing having a photon to electron converter disposed in a first opening at a first end thereof, the housing having an image sensor disposed in a second opening at a second, opposite end thereof; one or more deflection electrodes disposed inside of the housing; and a control power supply coupled to the deflection electrodes, the control power supply adapted to control the electro optical image-magnifying device.

In another aspect of the present invention, a electro optical image-magnifying device comprises a housing having a photon to electron converter disposed in a first opening at a first end thereof, the housing having an image sensor disposed in a second opening at a second, opposite end thereof; a plurality of deflection electrodes disposed inside of the housing; a control power supply coupled to the deflection electrodes, the control power supply adapted to control the electro optical image-magnifying device; and an image display and storage device disposed exterior to the housing adjacent to the image sensor.

These and other features, aspects and advantages of the present invention will become better understood with reference to the following drawings, description and claims.

### BRIEF DESCRIPTION OF THE DRAWINGS

FIG. 1 is a schematic diagram of an electro optical image-magnifying device with an image display system according to an exemplary embodiment of the present invention; and

FIG. 2 is a schematic diagram of the electro optical image-magnifying device of FIG. 1 with an ocular lens.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an electro optical image-magnifying device that uses both a light image and electrons to form and enlarge the image. The device may be attached to a microscope or a telescope and may be placed in such a way that an image plane may fall on a photocathode in the front of the device. The operator would view the image produced on a display screen, or thru an eyepiece, and would adjust a control power supply to achieve the desired magnification. The device may use both a light image and electrons to form and enlarge an image. The device may convert the light image into an electron wave representation. The electron wave representation may be manipulated electrically or magnetically, expanding its geometry and thus magnifying the image.

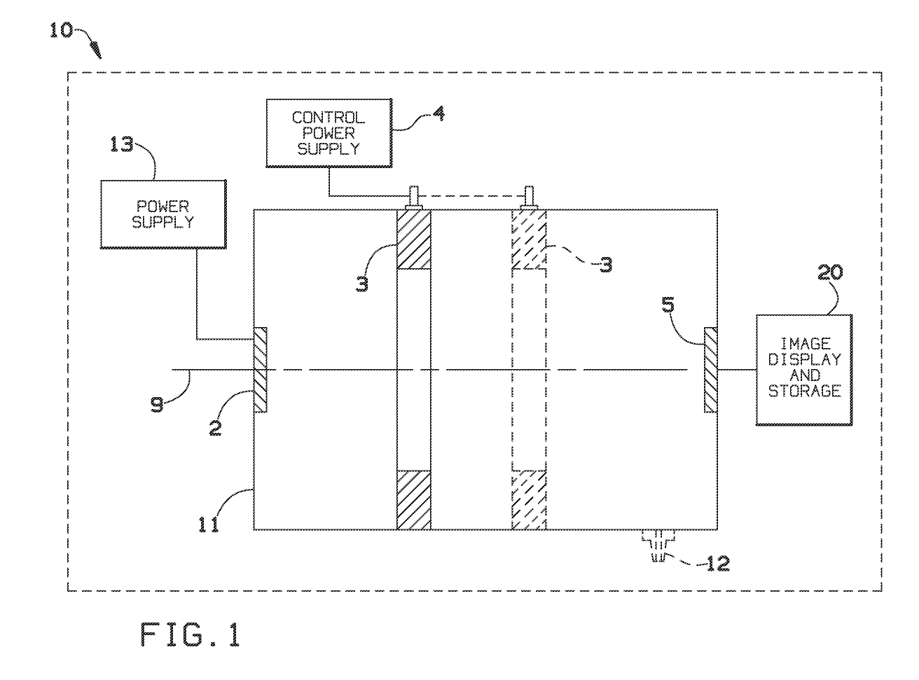

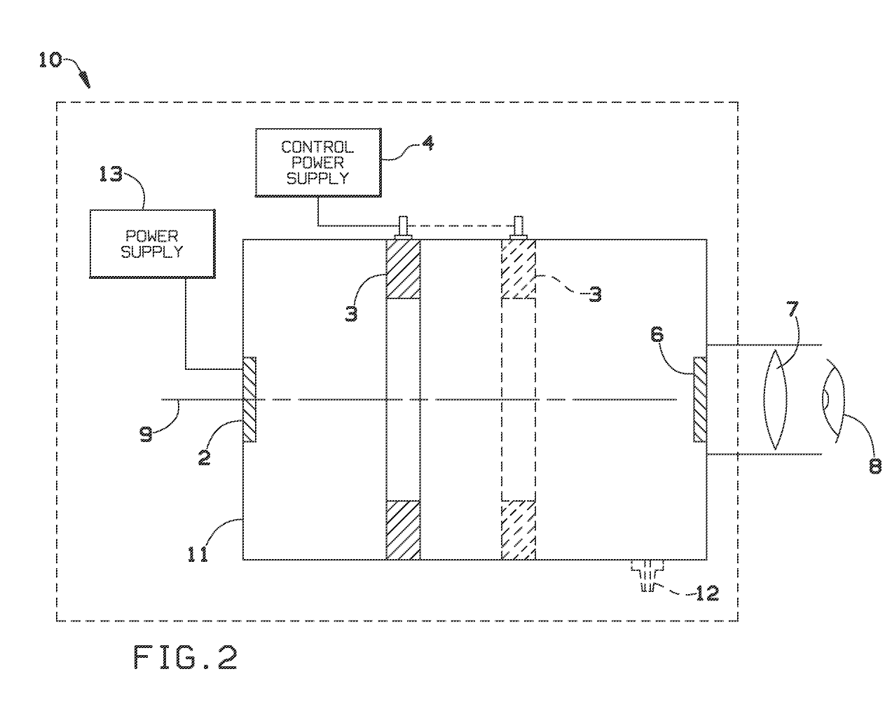

Referring now to FIGS. 1 and 2, schematic diagrams of an electro optical image-magnifying (EOIM) device 10 are shown according to an exemplary embodiment of the present invention. The EOIM device 10 may include a generally cylindrical housing 11 that may have the property of a vacuum chamber. A valve 12 may be connected to a vacuum pump (not shown) to remove air from the housing 11. A first opening (not shown) may be formed at a first end and a second opening (not shown) may formed at the second end of the housing 11. A photon to electron converter 2, for example, a photocathode, may be mounted in the first opening. A plurality of deflection electrodes 3 may be disposed inside of the housing 11. From 1 to about 5, typically from 1 to about 3 deflection electrodes 3 may be disposed inside of the housing 11. Having more than one deflection electrode 3 may improve the performance of the EOIM device 10. The deflection electrodes 3 may have a plurality of orifice diameters, however in most configurations, a typical orifice diameter is larger than 0.5 mm and typically would be in the range of 5.0 mm.

An image sensor 5, for example, a charge coupled device (CCD) or a phosphorescent screen 6, may be mounted in the second opening of the housing 11. The image sensor 5 may convert an enlarged electron image into electrical signal. The phosphorescent screen 6 may convert an electron image back to a visible light image. Elements of the EOIM device 10, the photon to electron converter 2, the orifice(s) of deflection electrode(s) 3, the sensor 5, and the phosphorescent screen 6 may be aligned along a central axis 9 or at least on the same axis without being unobstructed by any other object. Distances between the elements of the EOIM device 10 may be predetermined values to provide optimum performance.

A power supply 13 may be coupled to the photon to electron converter 2 to provide operating power. A control power supply 4 may be coupled to the deflection electrode(s) 3 to provide variable direct current (DC) voltage. The applied DC voltage may control the magnification of the EOIM device 10 by bending trajectories of electrons emitted from the photon to electron converter 2. In one exemplary implementation an image display and storage system 20, for example, a computer or a digital camera, may be coupled to the image sensor 5 to display enlarged images. In an alternative implementation, the enlarged image captured by the phosphorescent screen 6 may be viewed through an ocular lens 7 by an operator 8.

The EOIM device 10 may be attached to a microscope or telescope and could be placed so that the image plane may fall on the photon to electron converter 2. The operator may view the image and may adjust the control power supply 4 to achieve a desired magnification.

It should be understood, of course, that the foregoing relates to exemplary embodiments of the invention and that modifications may be made without departing from the spirit and scope of the invention as set forth in the following claims.

What is claimed is:

1. An electro optical image-magnifying device comprising:
a housing having a photon to electron converter disposed in a first opening at a first end thereof, the housing having an image sensor disposed in a second opening at a second, opposite end thereof;
one or more deflection electrodes disposed inside of the housing; and
a control power supply coupled to the deflection electrodes, the control power supply adapted to control the electro optical image-magnifying device.

2. The device of claim 1, further comprising an image display and storage device disposed exterior to the housing adjacent to the image sensor.

3. The device of claim 1, wherein the image sensor is selected from the group consisting of a charge coupled device and a phosphorescent screen.

4. The device of claim 2, wherein the image display and storage device is a computer or a digital camera.

5. The device of claim 1, further comprising a power supply for supplying power to the photon to electron converter.

6. The device of claim 1, further comprising a valve, wherein the valve is adapted to permit air to be vacuumed from the housing, and wherein the housing is adapted to maintain a reduced pressure atmosphere therewithin.

7. The device of claim 1, wherein the photon to electron converter, orifice of the deflection electrodes and the image sensor are aligned along a central axis.

8. The device of claim 1, further comprising an ocular lens disposed exterior to the housing adjacent to the image sensor.

9. An electro optical image-magnifying device comprising:
a housing having a photon to electron converter disposed in a first opening at a first end thereof, the housing having an image sensor disposed in a second opening at a second, opposite end thereof;
a plurality of deflection electrodes disposed inside of the housing;
a control power supply coupled to the deflection electrodes, the control power supply adapted to control the electro optical image-magnifying device; and
an image display and storage device disposed exterior to the housing adjacent to the image sensor.

10. The device of claim 9, wherein the image display and storage device is a sensor, a digital camera, or a user's eye, wherein, when the image display and storage device is the user's eye, an ocular lens may be disposed between the image sensor and the user's eye.
